(19) United States
(12) Patent Application Publication
(10) Pub. No.: US 2004/0145851 A1
(43) Pub. Date: Jul. 29, 2004

(54) Switchgear for generating a clock-controlled coil current that flows through a magnet coil

(75) Inventors: Szenn Otto, Leonberg (DE); Suchy Walter, Stuttgart (DE)

Correspondence Address: HOFFMANN & BARON, LLP, 6900 JERICHO TURNPIKE, SYOSSET, NY, 11791, US

(73) Assignee: FESTO AG & CO.

(21) Appl. No.: 10/756,619

(22) Filed: Jan. 13, 2004

(30) Foreign Application Priority Data
Jan. 25, 2003 (DE) 103 02 988.5

(51) Int. Cl. H01H 47/00; H01H 51/22

(52) U.S. Cl. 361/160

(57) ABSTRACT

The invention proposes a switchgear for generating a clock-controlled coil current that flows through a magnet coil arrangement (10), wherein said switchgear contains change-over means (16) for changing over from an initially higher pickup current to a lower retaining or operating current after a predetermined pickup time. A frequency detection stage (18) serves for monitoring the current control signal (Upwm) for the magnet coil arrangement and for changing over to the higher pickup current or the higher voltage causing the higher pickup current if the frequency signal fails to appear. This not only makes it possible to reliably detect an undercurrent with simple means, but also to initiate measures for the continued safe operation of the magnet coil arrangement (10).

The invention pertains to a switchgear for generating a clock-controlled coil current that flows through a magnet coil arrangement, wherein said switchgear contains a change-over means for changing over from an initially higher pickup current to a lower retaining or operating current after a predetermined pickup time.

A switchgear of this type is known, for example, from DE 297 15 925 U1. Such a switchgear is, for example, used in electromagnetic valves in order to reliably trigger a switching process by means of a higher pickup current, wherein the switchgear subsequently changes over to a lower retaining current in order to save energy and to maintain the heating as low as possible. The retaining current is adjusted to a predetermined value by means of clocking, wherein said value ensures that the desired switching state is preserved. This arrangement operates adequately as long as the supply voltage does not drop excessively. A drop in the supply voltage can initially be compensated by changing the pulse duty factor of the clocked voltage. However, this is only possible until the pulse duty factor reaches the value 1, in which case the supply voltage is applied directly and in a non-clocked fashion. The current decreases as the supply voltage drops further. This may cause the armature to be released and the switching state to change, for example, during relatively brief current fluctuations. Once the supply voltage reaches its original value again, it usually does not suffice for picking up the armature anew because the switchgear is adjusted only to the retaining current.

In order to detect malfunctions of this type, it is currently common practice to monitor the supply voltage, wherein a signaling unit is activated when the supply voltage drops below a predetermined limit value. The main disadvantage of such a monitoring process is the inaccurate measuring method, wherein it also needs to be taken into account that the coil current is not only dependent on the supply voltage, but also on the coil resistance, the coil temperature, etc. This frequently leads to unnecessary alarm signals and status signals, i.e., this type of information is unreliable.

The present invention is based on the objective of developing a switchgear of this type which not only makes it possible to reliably detect critical states, but also initiates automatic countermeasures for preventing a deactivation of the magnet coil arrangement.

According to the invention, this objective is attained by providing a frequency detection stage for monitoring the current control signal of a magnet coil arrangement and for changing over to the higher pickup current or the higher voltage causing the higher pickup current if the frequency signal fails to appear.

The advantage of the switchgear according to the invention can, in particular, be seen in the fact that it is possible to directly determine if the controlled current falls short of its nominal value by checking for the presence of a frequency signal. This means that all variables which negatively influence known voltage monitoring arrangements are automatically taken into account. A highly accurate frequency detection stage can be inexpensively manufactured because it is only necessary to detect two states, namely the presence or the absence of a frequency. By changing over to the higher pickup current and a higher voltage if the frequency signal fails to appear, it is possible to prevent the armature of the magnet coil arrangement from being released. Should the magnet coil arrangement be deactivated during an abrupt voltage drop, it is automatically activated again by the higher pickup current then in question being reintroduced.

Measures for realizing advantageous additional developments and improvements of the switchgear disclosed in claim 1 are defined in the dependent claims.

The change-over means preferably contains or is connected to a timer that changes over to the lower retaining or operating current after a predetermined time. This makes it possible to adjust the duration of the initially higher pickup current in accordance with the respective requirements.

The output of the frequency detection stage is connected to a change-over input of the change-over means in order to directly change over to the higher pickup current by means of a switching signal that is generated if the frequency signal fails to appear.

The current control signal monitored by the frequency detection stage preferably consists of the control signal for a driver or output stage of the magnet coil arrangement.

The frequency detection stage advantageously contains a first timer that triggers the change-over to the higher pickup current or the higher voltage after a predetermined time that begins with the interruption of the frequency signal. This prevents very brief voltage drops which usually do not cause the magnetic armature of the magnet coil arrangement to be released from triggering a change-over to the higher pickup current.

The frequency detection stage also contains a second timer that delays the change-over to the lower retaining or operating current after the clocking resumes. This ensures reliable pickup of the magnetic armature after an undercurrent state.

In one advantageous embodiment of the switchgear, the timer consists of a capacitor that can be charged by means of a resistor and discharged by the frequency signal or a signal derived from the frequency signal via a diode, wherein the voltage of the capacitor is compared with a reference voltage in a comparator. Essentially once one voltage is reached, a switching signal is triggered by the other voltage. Such a switchgear can be realized quite easily and inexpensively and also integrated, in particular, if the comparator(s) is/are realized in the form an amplifier, preferably an operational amplifier.

In addition to the change-over to the higher pickup current in case of a malfunction, it is also practical to provide an optical and/or acoustical signaling device in order to signal an interruption in the clocking and to thus alert the operator of the occurring malfunction.

One embodiment of the invention is illustrated in the figures and described in greater detail below. The figures show:

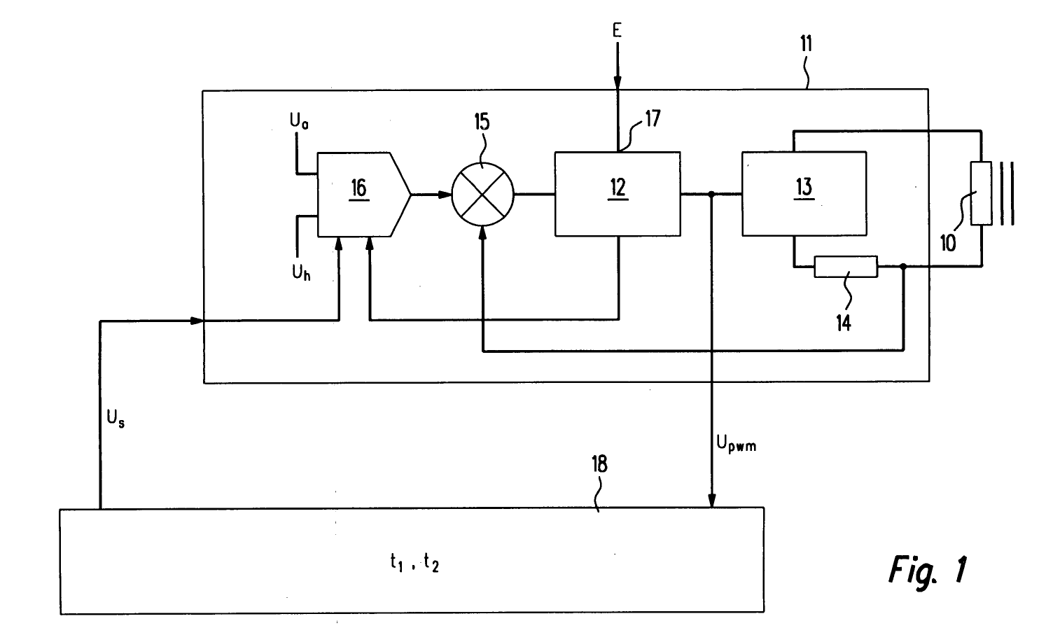

FIG. 1, a schematic block diagram of the entire switchgear with a frequency detection stage, and

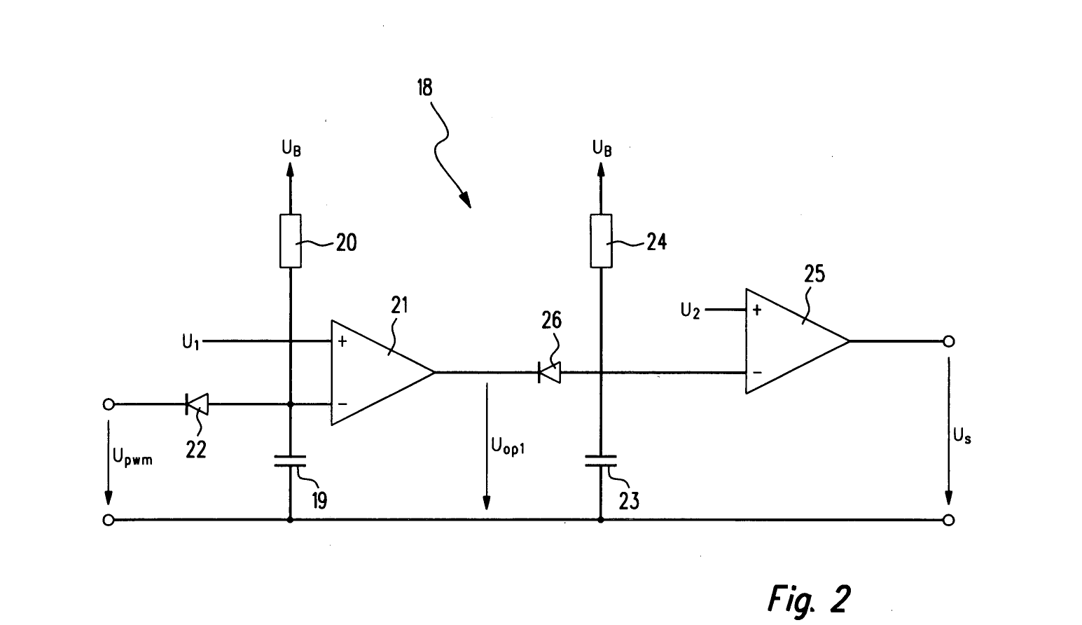

FIG. 2, a detailed representation of the frequency detection stage.

The block diagram according to FIG. 1 shows a known switchgear for lowering the initially higher pickup current to the retaining current during the operation of a magnet coil arrangement 10, namely within a bordered region 11. The magnet coil arrangement 10 consists, for example, of the magnet coil of an electromagnetic valve, a relay coil, a motor coil of a d.c. motor, a step motor or a linear motor.

A controller 12 generates a pulse-width modulated output signal for controlling the output stage or driver stage 13 of the magnet coil arrangement 10. A current measuring resistor 14 is arranged in the circuit of the magnet coil arrangement 10, wherein the measuring value of said measuring resistor is fed to a summing point 15 in the form of a voltage that is dependent on the actual current value. A change-over stage 16 feeds as the nominal current value either a nominal voltage Ua that defines the pickup current for the magnet coil arrangement 10 or a nominal voltage Uh that defines the retaining or operating current to the summing point 15. The controller 12 adjusts the pulse duty factor of its pulse-width modulated output voltage in dependence on the deviation.

The controller 12 is switched on by means of a switch-on signal E applied to a switch-on input 17, wherein the output of the controller generates a pulse-width modulated voltage signal Upwm, the pulse duty factor of which is controlled in accordance with the applied nominal voltage Ua in such a way that the driver stage 13 controls a predetermined pickup current for the magnet coil arrangement 10. After a predetermined time that ensures the reliable pickup of the armature of the magnet coil arrangement 10, a change-over to the lower nominal voltage Uh takes place, wherein this nominal voltage results in a correspondingly lower retaining or operating current that suffices for maintaining the magnet coil arrangement in the excited or switched state.

If the operating voltage drops, the controlled retaining or operating current can be maintained at the predetermined nominal value by changing the pulse duty factor. During a drop of the operating voltage, this change is, however, only possible until the pulse duty factor 1 is reached. At this pulse duty factor, the full operating voltage is applied to the magnet coil arrangement 10 in a non-clocked fashion. If the operating voltage drops even further, the retaining or operating current consequently drops below its nominal value such that the magnetic armature of the magnet coil arrangement 10 may be released. This may occur during relatively brief voltage drops or voltage fluctuations. When the operating voltage increases again, the retaining or operating current is readjusted to its nominal value that, however, does not suffice for returning the released magnetic armature to its operating position.

According to the present invention, a frequency detection stage 18 is provided in order to return the magnet coil arrangement 10 to its operative state after voltage fluctuations and after the associated release of the magnetic armature. This frequency detection stage constantly monitors the pulse-width modulated voltage signal Upwm at the output of the controller 12, namely with respect to the fact of whether a clocking or frequency is still present or not. If this is no longer the case, the retaining or operating current clearly is falling short of its nominal value and the magnetic armature of the magnet coil arrangement 10 may already have been released or is about to be released. Therefore the frequency detection stage 18 generates a switching signal Us at its output in such instances. This switching signal causes a change-over to the higher nominal voltage Ua in the change-over stage 16. This results in the higher pickup current for the magnet coil arrangement 10 such that the magnet coil arrangement 10 can be returned into the operative state. Naturally, this is only possible if the operating voltage has increased again, i.e., if only a brief fluctuation occurred. The higher pickup current remains adjusted until the frequency detection stage 18 once again detects a clocking. In this case, a change-over to the lower nominal voltage Uh takes place immediately or after a certain time delay analogous to the initial closing of the circuit.

A detailed representation of the frequency detection stage 18 for detecting undercurrent is illustrated in FIG. 2. A first capacitor 19 is continuously charged by the operating voltage U_{B} via a first charging resistor 20. In this case, the capacitor voltage is applied to the inverting input of a first operational amplifier 21. A fixed reference voltage U₁ is applied to the non-inverting input of the operational amplifier 21. The pulse-width modulated voltage signal Upwm at the output of the controller 12 is applied to the capacitor 19 by means of a first discharging diode 22 in such a way that the capacitor can be discharged in quiescent periods of the pulse-width modulated voltage signal Upwm.

A second circuit arrangement of identical design is connected in series to the first operational amplifier 21, wherein the second circuit arrangement consists of a second capacitor 23, a second charging resistor 24, a second operational amplifier 25 and a second discharging diode 26. In contrast to the first circuit arrangement, to which the pulse-width modulated voltage signal Upwm is applied, the output signal Uop1 of the first operational amplifier 21 is applied to the second circuit arrangement. The output signal of the second operational amplifier 25 forms the switching signal Us for the change-over stage 16.

If the current control operates correctly, the first capacitor 17 is periodically discharged by means of the first discharging diode 22 such that the output voltage Uop1 of the first operational amplifier 21 is high. This means that the second discharging diode 24 is blocked, and the second capacitor 23 is charged by means of the second charging resistor 24 such that the output voltage of the second operational amplifier 25, i.e., the switching signal Us, becomes zero.

If a sufficiently high retaining or operating current can no longer be adjusted due to the dropping operating voltage, the pulse-width modulated voltage signal Upwm no longer has a switching frequency or clocking. In this case, said voltage signal represents a continuous signal that lies above the reference voltage U₁. This means that the first discharging diode 22 is blocked, and the first capacitor 19 is charged by means of the first charging resistor 20 with a certain time constant. After a charging time t1 that is dependent on this time constant, the first operational amplifier 21 that is used as a comparator changes over such that its output signal Uop1 becomes zero. The second discharging diode 26 is now able to discharge the second capacitor 23 such that the second operational amplifier 25 also changes over and the resulting output signal can be used as the switching signal Us for changing over to the higher pickup current or the higher nominal voltage Ua, respectively. Due to this charging time t1, the first circuit arrangement consisting of the components 19-22 practically acts as a timer that only causes the change-over to the higher pickup current after a time delay t1 after no clocking of the voltage signal Upwm is detected.

After the return into the controlled current state, the pulse-width modulated voltage signal Upwm is once again clocked such that the first capacitor 17 is periodically discharged again by means of the first discharging diode 22. This causes the first operational amplifier 21 to change over again, and the second discharging diode 26 is blocked. The second capacitor 23 is now charged by means of the second charging resistor 24 with a second time constant until the second operational amplifier 25 that functions as a comparator changes over after a charging time t2. Consequently, the switching signal Us once again becomes zero and the change-over to the lower retaining or operating current takes place. Since the change-over is delayed by the charging time t2, the current remains adjusted to the higher value during the time t2. This ensures the reliable pickup of the magnetic armature of the magnet coil arrangement 10 after an undercurrent. The second circuit arrangement consisting of the components 23-26 consequently also acts as a timer with the time delay t2.

If it is, for example, not required or desired to change over from the higher pickup current to the lower retaining or operating current in a delayed fashion, the second circuit arrangement consisting of the components 23-26 can also be omitted or replaced with an inverter.

The frequency detection stage 18 naturally may also be realized in a digital fashion, for example, with two digital timing or time delay elements.

In a not shown manner, an optical and/or acoustical signaling device for indicating an impermissible undercurrent or for indicating an interruption in the clocking of the pulse-width modulated voltage signal Upwm may also be provided. This signaling device may, for example, be switched on by the switching signal Us or by the voltage Uop1 at the output of the first operational amplifier 21.

1. Switchgear for generating a clock-controlled coil current that flows through a magnet coil arrangement, with a change-over means for changing over from an initially higher pickup current to a lower retaining or operating current after a predetermined pickup time, characterized by the fact that a frequency detection stage (18) is provided for monitoring the current control signal (Upwm) of a magnet coil arrangement (10) and for switching over to the higher pickup current or the higher voltage causing the higher pickup current if the frequency signal fails to appear.

2. Switchgear according to Claim 1, characterized by the fact that the change-over means (16) contains or is connected to a timer that changes over to the lower retaining or operating current after a predetermined time.

3. Switchgear according to Claim 1 or 2, characterized by the fact that the output of the frequency detection stage (18) is connected to a change-over input of the change-over means (16).

4. Switchgear according to one of the preceding claims, characterized by the fact that the monitored current control signal is the control signal for a driver or output stage (13) of the magnet coil arrangement (10).

5. Switchgear according to one of the preceding claims, characterized by the fact that the frequency detection stage (18) contains a first timer (19-22) that triggers the change-over to the higher pickup current or the higher pickup voltage after a predetermined time (t1) that begins with the interruption of frequency signals.

6. Switchgear according to Claim 5, characterized by the fact that the frequency detection stage (18) contains a second timer (23-26) that delays the change-over to the lower retaining or operating current after the clocking resumes.

7. Switchgear according to Claim 5 or 6, characterized by the fact that the timer (19-22; 23-26) consists of a capacitor (19; 23) that can be charged by means of a resistor (20; 24) and discharged by the frequency signal (Upwm) via a diode (22; 26), wherein the voltage of said capacitor is compared with a reference voltage (U₁; U₂) by means of a comparator (21; 25), and wherein a switching signal can be triggered when one voltage is reached, namely by the other voltage.

8. Switchgear according to Claim 7, characterized by the fact that the comparator (21; 25) is realized in the form of an amplifier, in particular, an operational amplifier.

9. Switchgear according to Claim 5 or 6, characterized by the fact that the timer is realized in the form of a digital timer.

10. Switchgear according to one of the preceding claims, characterized by the fact that an optical and/or acoustical signaling device is provided for indicating an interruption in the clocking.
